(19) United States
(12) Patent Application Publication
(10) Pub. No.: US 2002/0195467 A1
(43) Pub. Date: Dec. 26, 2002

(54) Display module for water cooler

(76) Inventors: Athol E. Meder, Lincoln, NE (US); Glenn E. Meder, Lincoln, NE (US)

Correspondence Address: Van Dyke, Gardner, Linn & Burkhart, LLP, Suite 207, 2851 Charlevoix Drive, S.E., Grand Rapids, MI, 49546, US

(21) Appl. No.: 10/225,845

(22) Filed: Aug. 22, 2002

Related U.S. Application Data
(63) Continuation-in-part of application No. 10/009,213, filed on Nov. 8, 2001.
(63) A 371 of international application No. PCT/US00/12523, filed on May 8, 2000.
(60) Provisional application No. 60/314,774, filed on Aug. 24, 2001.
(60) Provisional application No. 60/133,352, filed on May 10, 1999.

(51) Int. Cl. B67D 5/62

(52) U.S. Cl. 222/146.6

(57) ABSTRACT

A modular advertising or display insert, module or replacement lid to a water cooler provides a display panel or image for viewing by a person getting water at or passing by the water cooler. The display panel may be a back-lit photograph or transparency, a flat or curved screen monitor or the like. The monitor may be remotely controllable via a modem or other remote communication means for remote changing of the pictorial image on the monitor. The display module is constructed to mount to the water cooler housing and to fit in place to maintain the design lines of the existing water cooler. The display module may be placed on a water cooler retroactively, after the water cooler has been placed at a targeted or desirable location, or may be incorporated onto a water cooler prior to placing the water cooler at the targeted or desirable location.

### CROSS REFERENCE TO RELATED APPLICATIONS

The present application claims priority of U.S. provisional application Ser. No. 60/314,774, filed Aug. 24, 2001 by Meder et al. for BOTTLELESS WATER COOLER (Attorney Docket MED02 P-100), and is a continuation-in-part of U.S. patent application, Ser. No. 10/009,213, filed Nov. 8, 2001 by Meder et al. for WATER DISPENSER (Attorney Docket PUR01 P-316), which is a §371 application of International Application No. PCT/US00/12523, filed May 8, 2000, which claims benefit of U.S. provisional application Ser. No. 60/133,352, filed May 10, 1999, which are all hereby incorporated herein by reference in their entireties.

### FIELD OF THE INVENTION

The present invention relates generally to water coolers and, more particularly, to bottleless water coolers.

### BACKGROUND OF THE INVENTION

Water coolers are devices that accept water from an external source and store a limited quantity of water for drinking and, less frequently, other purposes. The water coolers provide a means of dispensing the drinking water, usually through one or more spigots, nozzles, dispensers, or activation bars or the like, which may be activated by an individual desirous of obtaining water for drinking from the water cooler. Some water coolers provide a means to heat or chill the water, thus allowing the user a wider choice in the temperature of the water being dispensed.

Many water coolers use an inverted bottle of water as the water source. However, many other water coolers do not use an inverted bottle of water and have an internal water source or may receive a water supply from a remote source. A water cooler that does not have an inverted bottle at the top of the unit is commonly referred to as a bottleless water cooler or bottleless cooler. A bottleless cooler is a storage and dispensing device that may accept a bottle in the upright position in the base of the unit, or it may accept processed or treated drinking water from a remote device, such as, but not limited to, a distiller, a reverse osmosis system, a carbon filter, an ultraviolet purifier, or any other means of purification or treatment which may or may not be combined with other purification processes. In some applications, the water processing device or system may be a distiller, a reverse osmosis device, a filter, ozone, an ultraviolet purifier or the like, either alone or in combination, built into or attached to the water cooler.

### SUMMARY OF THE INVENTION

The present invention is intended to provide an advertising or display insert or module that is inserted or positioned or mounted at a cover or lid of a bottleless water cooler or between an upper portion of a bottleless water cooler and the cover or lid, such that the module of the present invention includes the cooler lid either at the top or bottom of the module or replaces the lid or obviates the need for a lid. The present invention is suited to all applications where an inverted bottle is not the source of water. However, aspects of the present invention may also be applied to water coolers using such an inverted bottle as the water source.

According to an aspect of the present invention, a display module includes a display portion and a housing portion. The housing portion is adapted to mount to an upper portion of a water cooler housing. The display portion functions to display information to the person or persons using the water cooler unit or standing close to the unit at an area at which the water cooler is positioned when the advertising module is mounted to the water cooler housing.

Preferably, the display module is removably mounted to the upper portion of the water cooler housing. The display module may be retrofitted onto an existing water cooler already in place at a particular location, or the module may be incorporated or designed into the bottleless water cooler at the place of manufacture of the water cooler, without affecting the scope of the present invention.

In one form, the water cooler is a bottleless water cooler. The display module may be adapted to mount to a cover portion of the bottleless water cooler. Alternately, the display module is adapted to mount to an upper portion of the bottleless water cooler housing and is further adapted to receive the lid or cover portion of the water cooler at an upper end of the display module.

In another form, the water cooler is a bottled water cooler using an inverted bottle at an upper portion thereof. The display module may be adapted to mount to the upper portion of the water cooler housing and may be positioned generally around the inverted water bottle.

According to another aspect of the present invention, a method of displaying messages or advertising includes providing a display module adapted for mounting to a water cooler. The display module includes a display panel for displaying information. The method includes mounting the display module to an upper portion of a water cooler housing of a water cooler at a targeted location. The display module displays information or messages at the display portion to the general area at which the water cooler is placed.

The display module may be mounted to an existing water cooler already in place at a targeted or desirable location. The method may include selecting an existing water cooler already in place at a targeted or desirable location and mounting an appropriate display module onto the selected water cooler.

The method may include removing the lid or cover of a bottleless water cooler and mounting the display module to the upper portion of the water cooler housing in place of the lid. The lid may then be mounted to the upper portion of the display module.

The present invention allows for the placement of a display image or message at the front of the module or an image at the front of the module plus an image on one or two sides of the module. In another configuration, the image may provide up to a 360° panoramic image.

The image or display module of the present invention may be created in a number of ways. Some examples include, but are not limited to, an image applied to the module by some means of adhesion, a flat or curved image which is sufficiently translucent to permit a light placed at the back of the image to illuminate the image from the rear, a flat or curved screen which may be connected to a modem or some other means which would permit the image on the monitor to be changed remotely, or the like.

The present invention is designed to be in many configurations which are adapted to correspond to fit the cross-section of a water cooler (and is particularly suited for bottleless coolers) and which may be inserted between the top of the water cooler and its lid or may be added to the top of the water cooler to provide an inserted module including the lid. In certain configurations, the image or display may be generally vertical. In other configurations, the image or display may be placed at an angle. An advantage of the present invention is that an existing water cooler can become a location where pictures or various sorts or third party advertising can be seen. The display module may display an advertising message for a particular product or service or may display other types of messages or information, such as, for example, photographs, safety posters, corporate logos, messages (such as public service messages, information messages, emergency messages, safety messages, motivational or inspirational messages and/or the like), third party advertising, and/or the like.

These and other objects, advantages, purposes and features of this invention will become apparent upon review of the following specification in conjunction with the drawings.

### BRIEF DESCRIPTION OF THE DRAWINGS

FIG. 1 is an exploded front elevation of a display module in accordance with the present invention, as being mounted on a bottleless cooler;

FIG. 2 is a front elevation of the bottleless cooler and display module of FIG. 1, as assembled together;

FIG. 3 is a rear elevation of the bottleless cooler and display module of FIG. 2;

FIG. 4 is an exploded front elevation similar to FIG. 1 of another display module in accordance with the present invention, with the module being mounted between an upper portion of a bottleless cooler and a cover of the bottleless cooler;

FIG. 5 is a top plan view of a rectangular display module on a bottleless cooler in accordance with the present invention;

FIG. 6 is a top plan view of another rectangular display module in accordance with the present invention;

FIG. 7 is a front upper perspective view of a curved or panoramic display module in accordance with the present invention, as mounted on a generally cylindrical water cooler;

FIG. 8 is a top plan view of a cylindrical display module in accordance with the present invention;

FIG. 9 is a front elevation similar to FIG. 2 of another display module having a full length display panel and mounted to a bottleless cooler in accordance with the present invention;

FIG. 10 is a front elevation similar to FIG. 2 of another display module in accordance with the present invention, as mounted to a bottleless cooler;

FIG. 11 is a side elevation of the bottleless cooler and display module of FIG. 10;

FIG. 12 is a side elevation similar to FIG. 11 of another display module mounted on a bottleless cooler in accordance with the present invention; and

FIG. 13 is an exploded front elevation of a display module in accordance with the present invention, as being mounted on a bottled water cooler.

### DESCRIPTION OF THE PREFERRED EMBODIMENTS

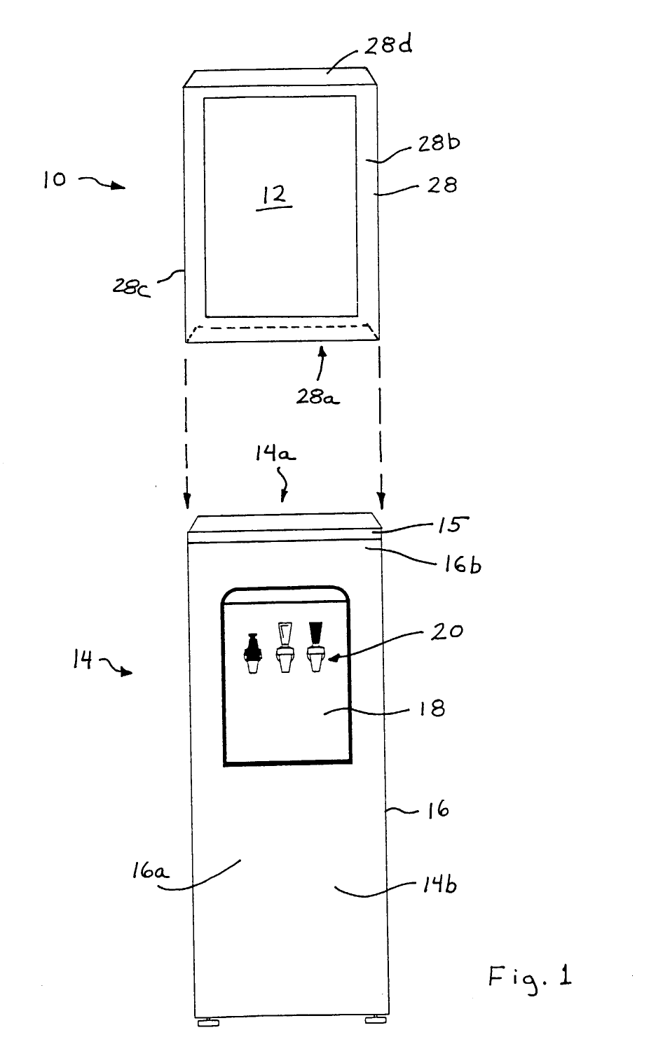

Referring now specifically to the drawings and the illustrative embodiments depicted therein, an advertising or display insert or module 10 includes a display screen or display panel 12 and is mountable to an upper portion 14a of a bottleless water cooler 14 (FIGS. 1-3). Display module 10 is adapted to be mountable, and preferably removably mountable, to the top or upper portion 16b of a housing or casing 16 of an existing bottleless water cooler 14, as discussed below, and may display advertisements or messages to persons at the area, such as at the hallway or room or the like, that is occupied by the bottleless water cooler 14. The display module 10 of the present invention may be mounted to an existing bottleless water cooler already in place at a particular area, such as a reception area, waiting room or the like, hallway, room or facility, such as, for example, a retail establishment, a school, a business office, an institution, a government office, and/or the like, or may be provided with a new bottleless water cooler to a particular area, hallway, room or facility or the like. The display module 10 is adapted to mount to an existing water cooler, so that an existing water cooler already in place at a particular location may be retrofitted with the display module of the present invention, with minimal if any changes to the water cooler being required.

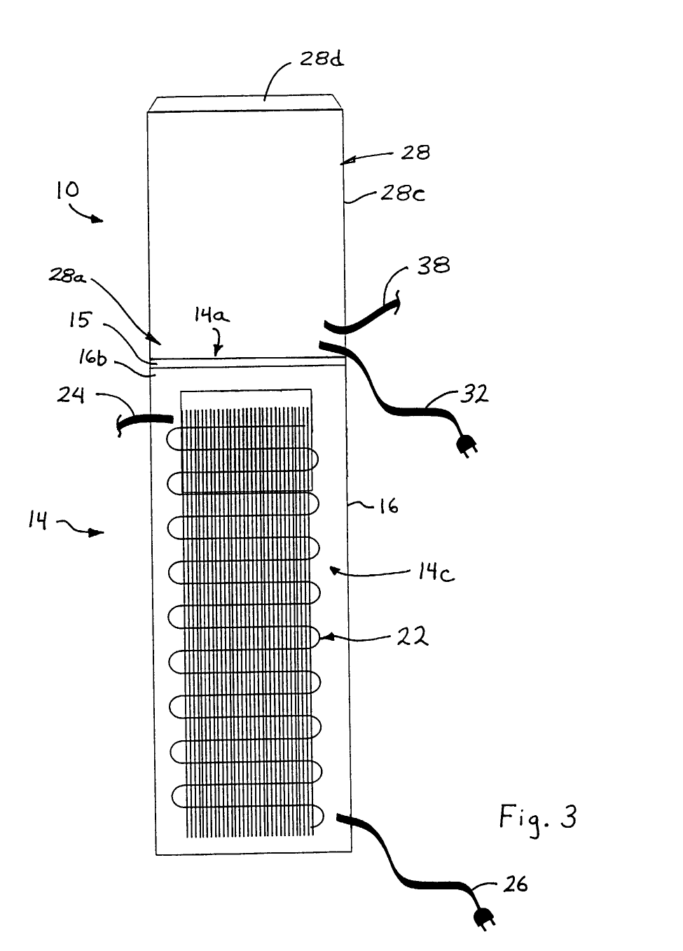

Bottleless water cooler 14 includes a shell or casing 16 which may be built on an internal frame (not shown). A front portion 14b of the water cooler 14 includes a generally recessed area 18 where one, two or three spigots or dispensers 20 may be situated. Each spigot 20 may dispense water at a different temperature. The bottleless water cooler 14 may or may not include a removable panel 16a at the front 14b of the cooler for easy access to the interior of the cooler. The top of the cooler 14 is closed over by a lid or cover 15, which may be a removable lid or cover, as discussed below, mounted to an upper portion 16b of housing or casing 16 of water cooler 14. As shown in FIG. 3, the back or rear portion 14c of the cooler 14 may include a condenser grid 22 to provide a heat exchange surface or heat exchange device for coolant or a cooling device (not shown).

Water cooler 14 may include a storage tank (not shown) situated within casing 16 and above the spigots 20. Although not shown in the drawings, the water cooler may include a compressor and refrigeration system, and/or a hot water vessel which incorporates a heating element to heat the water. The bottleless water cooler 14 dispenses drinking water from a water source other than an inverted water bottle. The water source may be either internal to the unit or external to the unit, such as via a water inlet line 24 (FIG. 3). The water cooler 14 may have an internal source of water purification or treatment, such as a distiller, a reverse osmosis system, filters of various types, ozone, ultraviolet light or the like, either alone or in combination with one or more other systems, or may have a bottle of purified or treated water stored upright inside the cooler with a pump or some device to pump water up to the reservoir above the spigots. Optionally, the bottleless cooler 14 may receive purified or treated water piped in from an external source. As shown in FIG. 3, the bottleless cooler 14 may be connectable to an electrical outlet by a power cord 26 which enters the cooler at the rear 14c of the unit.

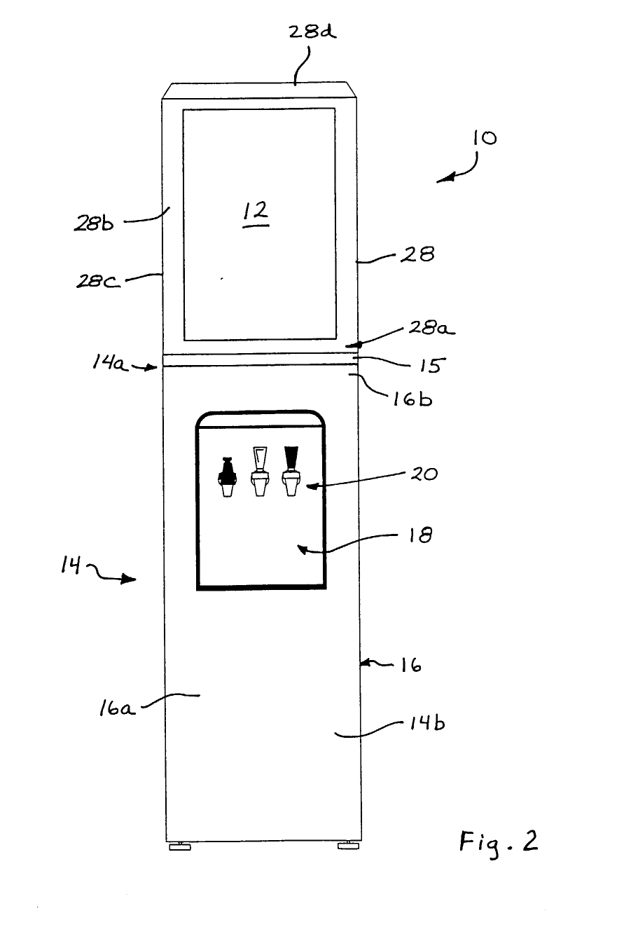

Display module 10 includes a frame or outer housing portion 28 which supports display 12. A lower, mounting portion 28a of housing portion 28 of display module 10 is adapted to generally fit the contours of the cooler lid or cover 15. The housing portion 28 may define a front portion 28b, side portions 28c of the display module and an upper lid portion or cover 28d. As shown in FIG. 1, the display insert or module 10 may be lowered or slid into place on top of cover 15 of water cooler 14. The lower mounting portion 28a is formed to generally engage the cover or lid 15 to position the display module 10 on top of the cover 15. Preferably, the mounting portion 28a of display module 10 may include tabs or flanges or brackets or the like (not shown), which may engage or be positionable at or along corresponding portions of the cover or lid 15, and through or at which screws, bolts, or other fasteners or clips may be placed to secure the display module 10 to the bottleless cooler 14. As shown in FIGS. 2 and 3, the outer housing portion 28 of display module 10 is constructed to fit in place at the top of the water cooler and preferably to maintain the design lines of the existing water cooler.

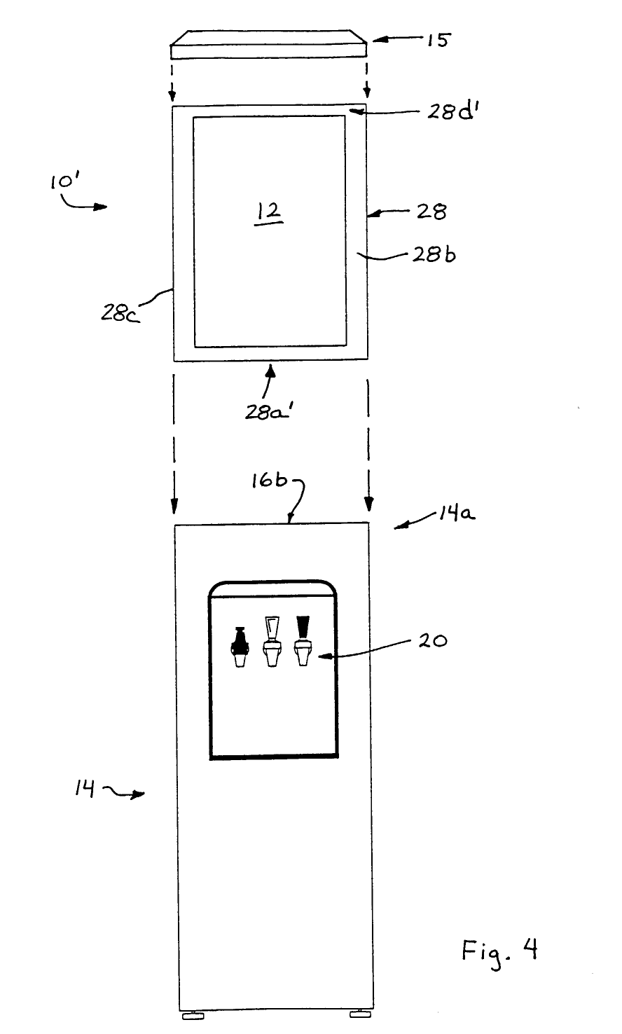

Optionally, as shown in FIG. 4, the lid 15 of water cooler 14 may be removed and an advertising or display insert or module 10′ may be mounted to the upper portion 16b of the housing 16 of the water cooler 14 in place of the lid 15. The lower mounting portion 28a′ of display module 10′ may be formed to generally correspond with the mounting portion of the lid or cover 15, such that the display module mounts or secures to the upper portion 16b of the water cooler housing 16 in the same or similar manner as the lid or cover 15. The lid or cover 15 of the cooler 14 may then be mounted to an upper portion 28d′ of the display module 10′ to close over the top of the display module 10′. Preferably, the upper portion 28d′ is formed to generally correspond with the shape and contours of the upper portion 16b of water cooler housing or casing 16, such that the cover 15 mounts or secures to the upper portion 28d′ in a same or similar manner as the cover mounted to the upper portion 16b of the water cooler housing 16. The display module 10′ thus provides a display module that is generally inserted between the bottleless water cooler 14 and its cover 15, and that preferably generally maintains the design lines of the existing water cooler between the upper portion of the water cooler and its cover.

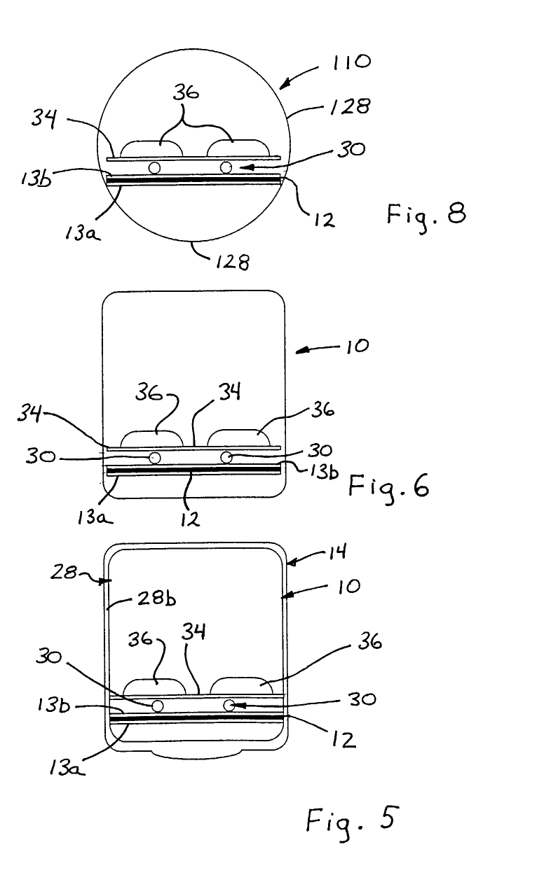

Display module 10 may include a display panel 12 positioned at or along the front portion 28b of display module 10, and/or may include one or more display panels (not shown) positioned at or along the side portions 28c of display module 10. Optionally, display panel 12 may be a semi-transparent plastic display panel. As shown in FIGS. 5, 6 and 8, the display panel 12 may be backlit or otherwise illuminated by an illumination source or multiple illumination sources or bulbs 30 positioned within housing 28, in order to enhance the visibility of the display and thus enhance the effectiveness of any advertisement or message being displayed thereon. Clearly, however, display panel 12 may comprise other materials and/or may be otherwise illuminated or not illuminated, without affecting the scope of the present invention. A power cord 32 (FIG. 3) may be provided at the rear of the display module to plug into an outlet at the location of the existing water cooler.

As shown in FIGS. 5, 6 and 8, display panel 12 may be positioned between spaced apart protective covers or panels 13a, 13b at a front and rear side of the panel to protect and retain the display panel in the display module. The protective panels 13a, 13b may generally define a track therebetween along which the display panel 12 may slide generally vertically into position. The track may allow for easy changing of the display panel to other display panels for displaying different information or messages by removing one display panel and inserting a new display panel in its place. The illumination sources 30 and protective panels 13a, 13b may be mounted to a backplate 34, which may be mounted to housing 28 of display module 10, such as at sidewalls 28c or lower mounting portion 28a. The backplate 34 provides a mounting plate or bracket for the illumination sources, panels, controls (discussed below) and/or the like within the display module of the present invention.

Optionally, display module 10 may provide or display various information or messages or images, such as, for example, photographs, safety posters, corporate logos, messages, such as public service messages, information messages, emergency messages, safety messages, motivational or inspirational messages, third party advertising, and/or the like, without affecting the scope of the present invention.

Display panel 12 may be single panel at one or more sides of the display module or may comprise a wraparound display, which provides a substantially continuous display around the sides and front of the display module, without affecting the scope of the present invention. Additionally, the display panel 12 may be manually or automatically or remotely changeable to alternatingly or intermittently display two or more distinct messages. For example, the display panel may be removable and replaceable at the housing of the display module, or the display module may be removable and replaceable on the bottleless cooler. Alternately, the display may comprise a plurality of movable panels which may rotate, slide or otherwise move to expose a different side of the panels to a viewer of the display, thus intermittently providing different displays or advertisements at the advertising or display module and water cooler. Such display panels are implemented in various billboards and thus known in the field of billboards and signs.

It is further envisioned that the display panel 12 of display module 10 may comprise a video monitor or screen, such as a television screen, computer monitor, LED screen, or any other screen, monitor or the like, which is operable to display a continuous advertising message or information message, such as a pre-recorded message on a video tape, or disk or other data storage means. The video monitor or screen may be operable to change the message periodically or in response to an electrical signal. For example, a control or controls 36 (FIGS. 5, 6 and 8) may be mounted to backplate 34 within the display module and may be programmable to periodically change or modify the display message or image. The display image may also be adjustable in response to various inputs, such as a certain time of the day or week. It is further envisioned that the display image or monitor may be remotely controllable to allow the message to be changed periodically from a remote location. For example, an operator of the display may be able to alter or change the message being viewed on the monitor via an internet connection or the like. The remote control of the display may be connected to the display module via a communications line 38 (FIG. 3) connected to display module 10. The communications line 38 may be connected to a phone jack or network jack or other connection which may already be in place at the location of the existing water cooler. Alternately, the control 36 may be connected to a receiver (not shown) or the like which receives a signal, such as a radio frequency (RF) signal or the like, from a remote location and communicates a corresponding electronic signal to the control. The message being displayed may be changed to provide an emergency message or the like in certain situations where such a message may be desirable, such as to provide a warning or the like to the people in the vicinity of the display module.

Optionally, the advertising or display insert or module of the present invention may include an audio device (not shown), which is operable to convey an audible message to a user of the water cooler or a person passing by or in the general vicinity of the water cooler. The audible message may be associated with the display message or may provide additional information relative to the water cooler, location of the water cooler, and/or the advertised products and/or services. The audible message may be a continuous message or may be a message which is activated in response to detection of a consumer at the water cooler, such as via a motion sensor or the like (not shown). For example, the audible message may thank a person at the water cooler and display module for shopping at the location or store where the water cooler is located, or for visiting the office where the water cooler is located, and may further remind them to shop or visit the business or location in the near future.

The display panel may be continuously illuminated or may otherwise be operable when the water cooler is activated or may be activated for a period of time following an electrical signal, which may be triggered via a manual activation of the display module or a detection of a consumer at the water cooler.

Optionally, display module 10 provides an advertising display panel or image 12 that is associated with a product or service independent from the water cooler or the water being dispensed therefrom. Most preferably, the product or service being advertised on display module 10 is associated with the location at which the water cooler is placed. For example, an advertisement for various banking services may be provided by mounting an appropriate advertising or display module on a water cooler already positioned or placed in a lobby of a bank, such that customers walking into the bank who pass by the water cooler or who stop to get a drink can see the advertising message at the display module mounted to the water cooler. Alternately, the display panel may convey an advertising message associated with a prescription or non-prescription drug or other medical product or products or services. Such an advertising module and display may be mounted to a water cooler already positioned or placed at a doctor's office, medical clinic, hospital, or the like, such that when a person stops to get a drink of water, they are exposed to an advertisement associated with a product or service associated with the business or office which they are currently visiting.

Optionally, the display may be used to advertise a product for a third party not directly related to the water cooler supplier or the location of the water cooler, without affecting the scope of the present invention. Display module 10 may provide an advertisement to promote other products and/or services which are independent of the bottleless water cooler at which the advertising or display insert or module is positioned and the water being dispensed therefrom. Preferably, the promotional display promotes goods or services related to the targeted location or environment at which the bottleless cooler 14 is positioned, such that potential consumers of the advertised goods/services will have the opportunity to view the advertisement as they pass by or as they get themselves a drink of water from bottleless cooler 14. For example, the display module may display a third party advertisement for a teeth whitening product supplied by a third party manufacturer and may be mounted to a water cooler at a lobby or waiting room of a dentist office.

The display module thus may be mounted to any existing water cooler already placed at any location where there is a high likelihood for use or viewing of the advertising display by potential consumers of the product or service being advertised. This provides highly effective advertising, since the consumers are being exposed to the advertisement at a time and place where they are in the vicinity of and/or in view of the product/service being advertised, and thus most likely to be interested in the message being conveyed and to be able to act in response thereto. Because the advertising module and display is positioned on top of or above a housing of an existing water cooler, the display may be placed at a preferred location, such as a reception area of office or the like, where the business or office may otherwise not wish to have an advertisement placed, but where a water cooler, such as a bottleless cooler, is already positioned.

In order to further enhance the desirability of placing a display module of the present invention at a water cooler at an office, it is further envisioned that a display method may provide an advertising or display insert or module including a display, which is associated with a product or service, at a water cooler already positioned at a targeted or desirable location, which may also be associated with the advertised product or service. The display panel of the display module, or right to advertise on the advertising or display module, may be purchased by an advertiser of the product or service in order to sponsor the advertiser's specific products or services. Because the sponsor then pays for the advertising, and the advertising or display module is mounted to a water cooler already placed at the location of interest to the advertiser, there may be no additional installation and service charges to the targeted location or organization, such as a doctor's office, bank or the like. The advertiser may be independent from the targeted location or business, such as a prescription or nonprescription drug company which provides an advertisement at a doctor's office, clinic, hospital or the like. Alternately, the advertiser may be associated with or directly related to the targeted business or location, such as a bank which advertises their banking services in the lobby of a branch of the bank. The targeted account or location may be contacted by the advertiser, or by the provider of the advertising or display module, or by any other related party, to get approval on the concept prior to placing the display module at the existing water cooler already in place at the targeted location. The advertiser may take over payment of the service and/or maintenance fees due for the water cooler already placed at the targeted location.

Accordingly, the advertising or display method provides benefits to all parties involved. The advertiser is provided with an optimal advertising location in an area which experiences generally high traffic of potentially interested or motivated consumers. The location or target organization also benefits by having the costs associated with their existing water cooler absorbed or at least partially absorbed by the advertiser.

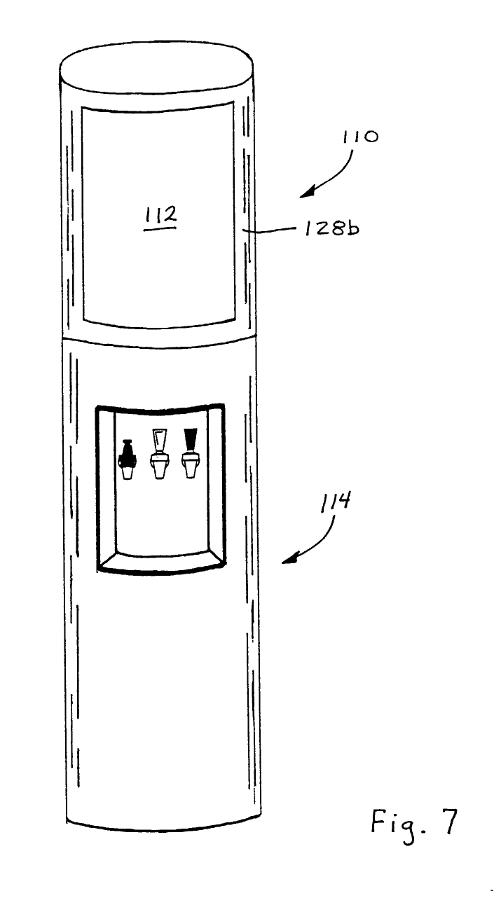

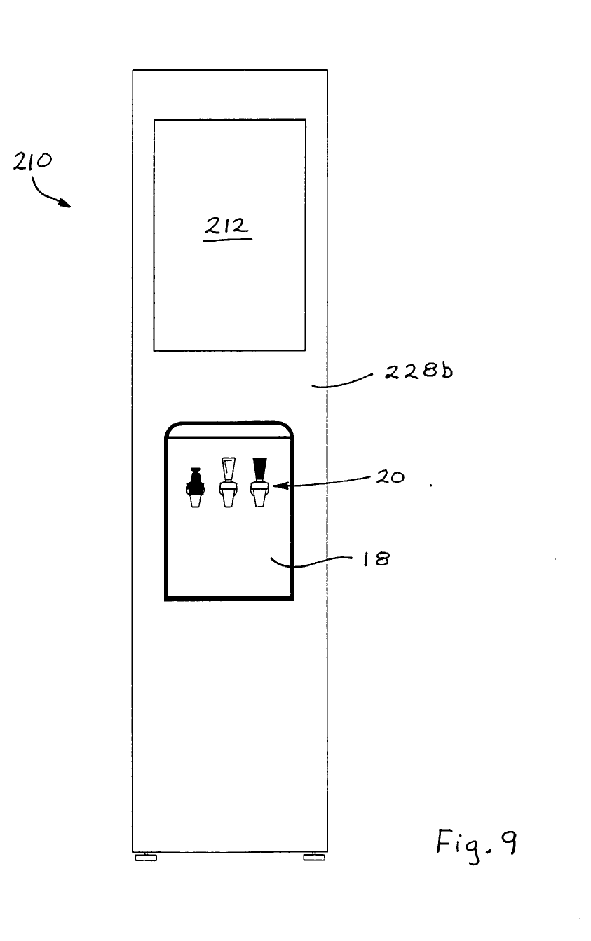

Referring now to FIGS. 7 and 8, an advertising or display insert or module 110 provides a generally cylindrical or curved front surface 128b for a generally curved display panel or image 112. The display module 110 is formed to generally correspond with a similarly curved or cylindrical water cooler 114. The display module 110 may mount to the cover of the water cooler or may mount to an upper portion of the water cooler after the cover is removed, as discussed above with respect to display modules 10, 10′. Display module 110 is otherwise substantially similar to display modules 10, 10′ discussed above, such that a detailed description of the display module will not be repeated herein.

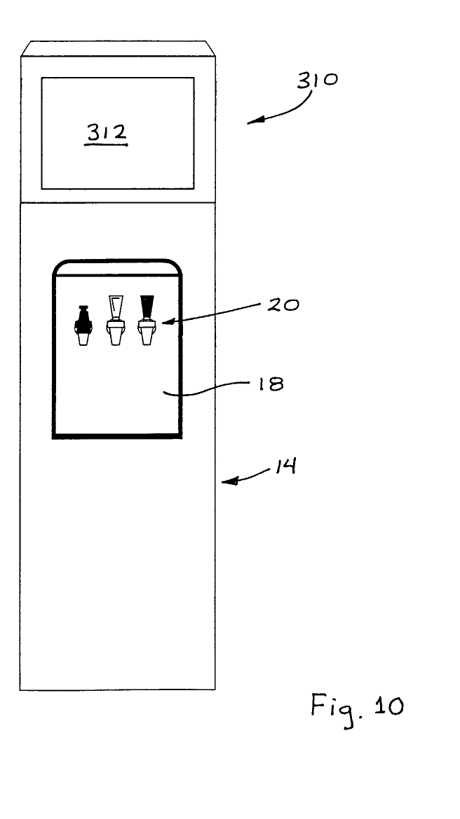

Optionally, and with reference to FIG. 9, an advertising or display insert or module 210 may provide a full length front panel 228b which fits over or is positionable adjacent to and over the front surface of the water cooler (not shown in FIG. 9). The display module 210 may also include full length side and/or rear panels (not shown) to substantially encase the water cooler at which the display module is mounted. Similar to the embodiments discussed above, display module 210 provides a display panel or image 212 positioned at the front, sides and/or rear portions of the display module.

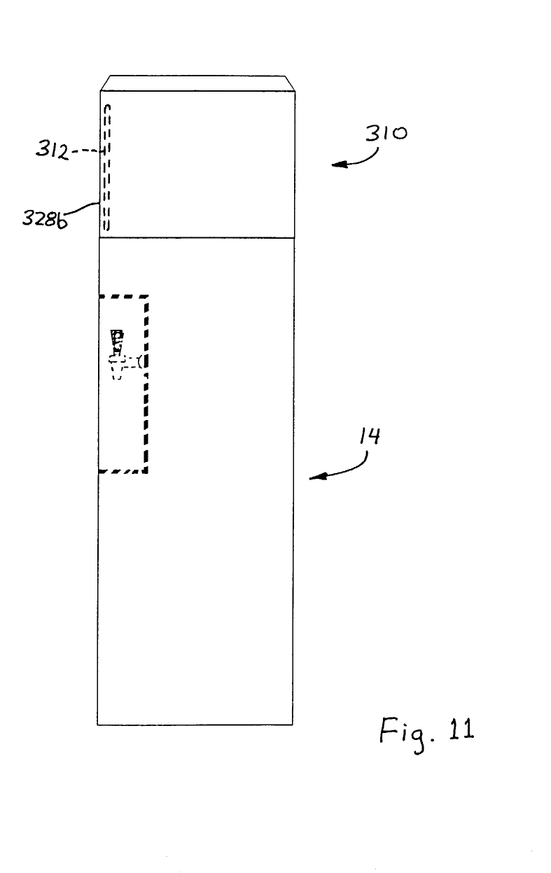

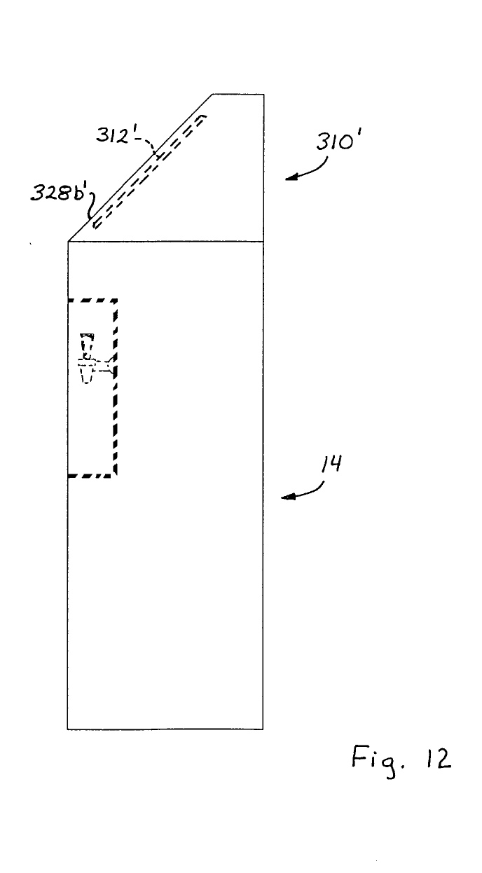

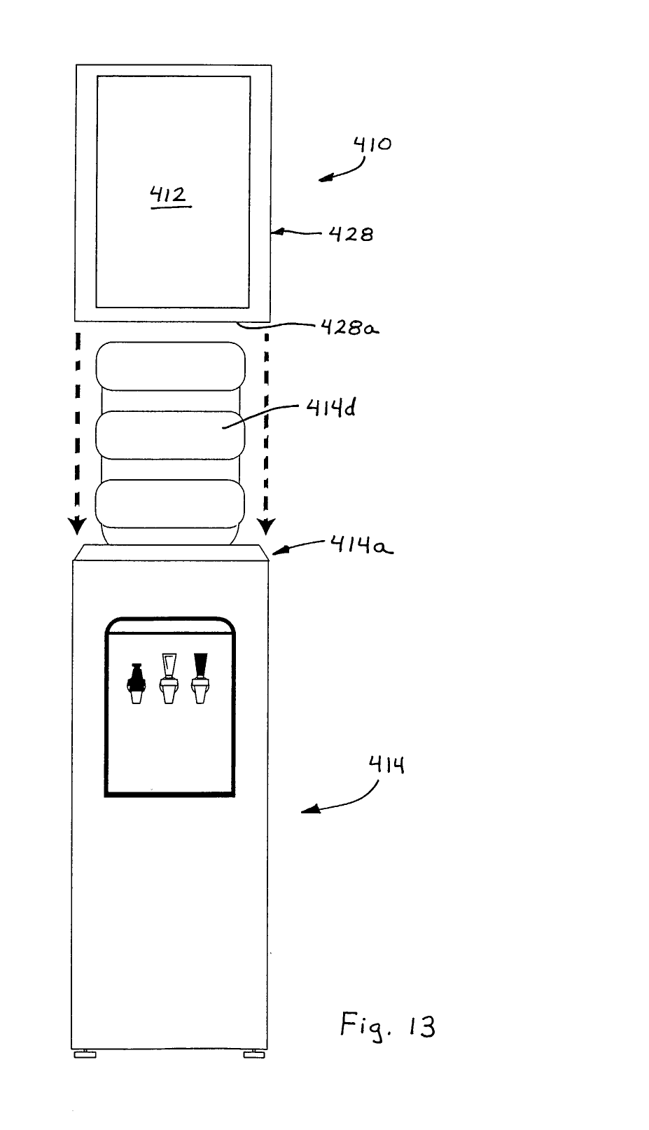

Referring now to FIG. 10, an advertising or display insert or module 310 may be mounted to an existing bottleless water cooler 14. The display module 310 includes a display image or panel 312, which may be a flat or curved screen or monitor, and which may include a modem (not shown) for remote control of the display screen to change the images being displayed. As shown in FIG. 11, display panel 312 may be generally vertically oriented on the forward surface or panel 328b of display module 310. Optionally, however, and as shown in FIG. 12, a display panel 312′ may be angled along an angled forward surface or panel 328b′ of an advertising or display insert or module 310′, without affecting the scope of the present invention.

Although shown and described as being mounted on a bottleless water cooler 14, it is envisioned that an advertising or display insert or module 410 in accordance with the present invention may be mounted over and substantially around an inverted water bottle 414d of a bottled water cooler 414. The housing 428 of the display module 410 may be configured to substantially encase the inverted water bottle, with a lower mounting portion 428a of the housing 428 being adapted or configured to mount to and to be secured to the upper portion or cover 414a of water cooler 414, in a similar manner as discussed above. As discussed above, the display module 410 provides a display panel or image 412 for displaying an advertising message or other information or messages to a person getting a drink from or passing by the water cooler 414. The display module 410 is adapted to mount to an existing water cooler, so that an existing water cooler may be retrofitted with the display module, with minimal if any changes to the water cooler being required.

Therefore, the present invention provides an advertising or display insert or module which may be added to an existing water cooler already in place at a particular location. Regardless of the cross-section shape or dimensions of the cooler, the advertising or display insert or module of the present invention provides a device built or configured with a cross section approximately equal to the cross sectional dimensions of the targeted water cooler. The display module consists of an internal or external frame which may fit between the top of a cooler and its cover or lid, or in some instances the invention will incorporate the lid into its design. In some embodiments of the present invention, such as shown in FIGS. 1-3, 7, 8 and 11, the image or images or panels may be in a generally vertical orientation. However, in other embodiments of the present invention, the image or panel may be at an angle other than vertical, such as shown in FIG. 12.

It is further envisioned that the image may be revolving. In another configuration, the image may have fiber optic effects. In another configuration, the image may be created on a curved or flat screen monitor which may or may not have a modem or similar device which would allow the presentation of moving or static images which could be changed remotely.

Therefore, the present invention provides a module or device into or onto which images or panels, either backlit or not, can be placed. Such images may include, but not be limited to, photographs, safety posters, corporate logos, messages, such as public service messages, information messages, emergency messages, safety messages, motivational or inspirational messages, third party advertising and/or the like. In one configuration, the display module of the present invention consists of a frame which is designed to hold one or more images. Such images can be on the front surface or one or both sides. In one configuration, the image may be continuous for the front and both sides of the invention, and may be curved or generally cylindrical or semi-cylindrical to provide a panoramic image or panel. Such a configuration may incorporate an internal frame holding the images. The panel or image may substantially encapsulate the frame, such that the frame may not be obvious to a person viewing the water cooler.

The present invention provides a modular device which may be inserted between the top of a bottleless cooler and the lid of the bottleless cooler. The specific dimensions and curve radii will depend on the design of the upper portion of the existing bottleless cooler. Alternately, a modular device and incorporated lid of the present invention may be fitted to the lid or cover of a bottleless cooler, with the specific dimensions and curve radii depending on the design of the lid of the existing bottleless cooler. The present invention thus provides a mechanism to accept and provide images of various types. The images may include, but are not limited to, translucent or transparent images through which light is passed, video images, static images, and/or the like. Another form of image may be a curved or flat screen monitor which may have a related modem which can utilize external sources to control the image on the monitor. The present invention thus provides a mechanism for inserting or adding images into or onto an existing water cooler. The images may be changeable, such as via a track along which an image or panel may slide into place, or via automatic or remote control of a display screen or the like. The display may be a back-lit panel with a light source behind the panel or a light source which is generally perpendicular to the panel. Where the panel is back-lit, a power source is provided. The power source may be a battery or an external electrical supply.

Changes and modifications to the specifically described embodiments can be carried out without departing from the principles of the present invention, which is intended to be limited only by the scope of the appended claims, as interpreted according to the principles of patent law.

The embodiments of the invention in which an exclusive property or privilege is claimed is defined as follows:

1. A display module adapted for mounting to a water cooler housing of a water cooler, said display module comprising a display portion and a housing portion, said housing portion being adapted to mount to an upper portion of a water cooler housing, said display portion functioning to display information to an area at which a water cooler is positioned when said display module is mounted to the water cooler housing.

2. The display module of claim 1, wherein the water cooler is a bottleless water cooler, said housing portion being adapted to mount to an upper portion of the bottleless water cooler housing.

3. The display module of claim 1, wherein the water cooler has a cover removably mounted at an upper portion of the water cooler housing, said housing portion being adapted to mount to the upper portion of the water cooler housing when the cover is removed from the water cooler housing.

4. The display module of claim 3, wherein said housing portion is adapted to receive the cover of the water cooler at an upper portion of said housing portion.

5. The display module of claim 1, wherein the water cooler is a bottleless water cooler having a cover, said housing portion being adapted to mount to a cover of a bottleless water cooler.

6. The display module of claim 1, wherein the water cooler is a water cooler having an inverted bottle at an upper portion thereof, said housing portion being adapted to mount to the upper portion of the water cooler housing and at least partially surround the inverted water bottle.

7. The display module of claim 1, wherein said display module is adapted for removably mounting to a water cooler housing.

8. The display module of claim 1, wherein said display portion is removably mounted to said housing portion.

9. The display module of claim 1, wherein said display portion comprises a semitransparent display panel.

10. The display module of claim 9 including an illumination source, said display panel being backlit by said illumination source when said illumination source is activated.

11. The display module of claim 1 including an illumination source which is operable to illuminate said display portion.

12. The display module of claim 1, wherein said display portion is variably operable to provide at least two distinct messages in response to an electrical signal.

13. The display module of claim 1, wherein said display portion comprises a video monitor which is operable to display at least one of a video image and a video message.

14. The display module of claim 13, wherein said video monitor comprises a television screen.

15. The display module of claim 13, wherein said video monitor comprises a computer monitor.

16. The display module of claim 13, wherein said display portion is remotely controllable and is variably operable to display two or more distinct messages.

17. The display module of claim 1 including an audio device which is operable to communicate an audible message to a consumer in response to an electrical signal.

18. The display module of claim 1, wherein said display portion comprises a generally vertical display portion.

19. The display module of claim 1, wherein said display portion comprises an angled display portion oriented at an angle with respect to a generally vertical plane.

20. The display module of claim 1, wherein said display portion comprises at least one of a generally planar display panel and a non-planar display panel.

21. A method of displaying information comprising:
providing a display module adapted for mounting to a water cooler housing, said display module including a display portion for displaying information;
mounting said display module to an upper portion of a water cooler housing of a water cooler at a targeted location; and
displaying information at said display portion of said display module.

22. The method of displaying information of claim 21 including providing a water cooler to a targeted location.

23. The method of displaying information of claim 21 including selecting an existing water cooler already placed at a targeted location.

24. The method of displaying information of claim 21 including removing a cover of the water cooler and mounting said display module to an upper portion of the water cooler housing in place of the cover.

25. The method of displaying information of claim 24 including mounting the cover of the water cooler to an upper portion of said display module.

26. The method of displaying information of claim 21, wherein mounting said display module to an upper portion of a water cooler housing comprises mounting said display module to a cover of a water cooler housing.

27. The method of displaying information of claim 21, wherein before the step of mounting said display module, said method comprises selling advertising rights to sponsors for advertising on said display portion of said display module.

28. The method of displaying information of claim 21, wherein said display portion of said display module comprises a display panel mounted at a housing of said display module.

29. The method of displaying information of claim 28, wherein said display panel comprises a back lit display panel, said method further comprising the step of illuminating said display panel.

30. The method of displaying information of claim 29, wherein said display panel comprises a semi-transparent display panel.

31. The method of displaying information of claim 21, wherein said display portion comprises at least one of a generally planar display panel and a non-planar display panel.

32. The method of displaying information of claim 21, wherein said display portion of said display module comprises a video monitor.

33. The method of displaying information of claim 32 including remotely controlling said display portion via a remote control to display at least one of multiple messages.

34. The method of displaying information of claim 21, wherein mounting said display module comprises removably mounting said display module.

35. The method of displaying information of claim 21, wherein said display portion is removably mounted to a housing portion of said display module.

36. The method of displaying information of claim 21, wherein said display module is actuatable in response to a detection of a user at the water cooler.

37. The method of displaying information of claim 21, wherein said display module includes an audio device operable to generate an audio signal.

38. The method of displaying information of claim 37, wherein said audio signal conveys an audible signal associated with said display portion of said display module.

39. The method of displaying information of claim 37, wherein said audio device is operable to generate an audible signal in response to detection of a user at the water cooler.
